(19) United States
(12) Patent Application Publication
(10) Pub. No.: US 2010/0315812 A1
(43) Pub. Date: Dec. 16, 2010

(54) LED LAMP

(75) Inventor: YOU-XUE LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: Fu Zhun Precision Industry (Shen Zhen) Co., Ltd., Shenzhen City, Guangdong Province (CN); Foxconn Technology Co., Ltd., Tu-Cheng,Taipei Hsien (TW)

(21) Appl. No.: 12/563,169

(22) Filed: Sep. 21, 2009

(30) Foreign Application Priority Data
Jun. 12, 2009 (CN) 200910303218.3

(51) Int. Cl. F21V 5/00; F21S 8/08; F21V 29/00

(52) U.S. Cl. 362/235; 362/418; 362/373

(57) ABSTRACT

A light emitting diode (LED) lamp includes a base, a connecting member and a lamp body. The base defines therein an opening receiving the connecting member. The connecting member is pivotally connected to the base. The lamp body has an annular holder at a bottom thereof and an LED module received in the annular holder and exposed outside through bottoms of the base and the connecting member. The annular holder is received in the connecting member and pivotally connected to the connecting member. The connecting member is rotatable relative to the base about a first axis, while the lamp body is rotatable relative to the connecting member about a second axis perpendicular to the first axis.

### BACKGROUND

1. Technical Field

The present disclosure relates to a light emitting diode (LED) lamp, and particularly to an LED lamp having an adjustable illumination angle.

2. Description of Related Art

With the continuing development of scientific technology, LEDs have been widely used for illumination due to their high brightness, long life-span, and wide color gamut.

An LED lamp is a type of solid-state lighting device that utilizes LEDs as a source of illumination.

A conventional LED lamp generally comprises a lamp cover and a plurality of LEDs attached to an inner wall of the lamp cover. However, the lamp can only be assembled in a predetermined form with its illumination area of light emitted by the LEDs of the conventional LED lamp restricted to a fixed value along a predetermined direction of the LED lamp. A problem is that the conventional LED lamp fails to provide an adjustable illumination area with various irradiating angle. So the conventional LED lamp cannot satisfy a requirement that an illumination area and an illumination angle are variable, which may be required for some applications.

What is needed, therefore, is an LED lamp which can overcome the above-mentioned disadvantages.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of an LED amp in accordance with an embodiment of the present disclosure.

FIG. 2 is an inverted view of the LED lamp of FIG. 1.

FIG. 3 is an exploded view of the LED lamp of FIG. 2.

FIG. 4 is a cross section view of the LED lamp taken along line IV-IV of FIG. 1.

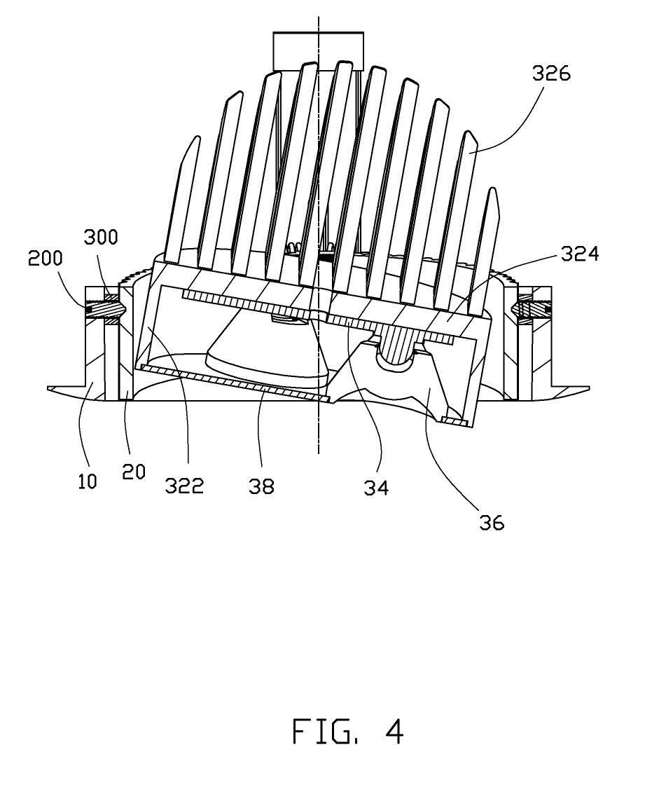

FIG. 5 is a cross section view of the LED lamp taken along line V-V of FIG. 1.

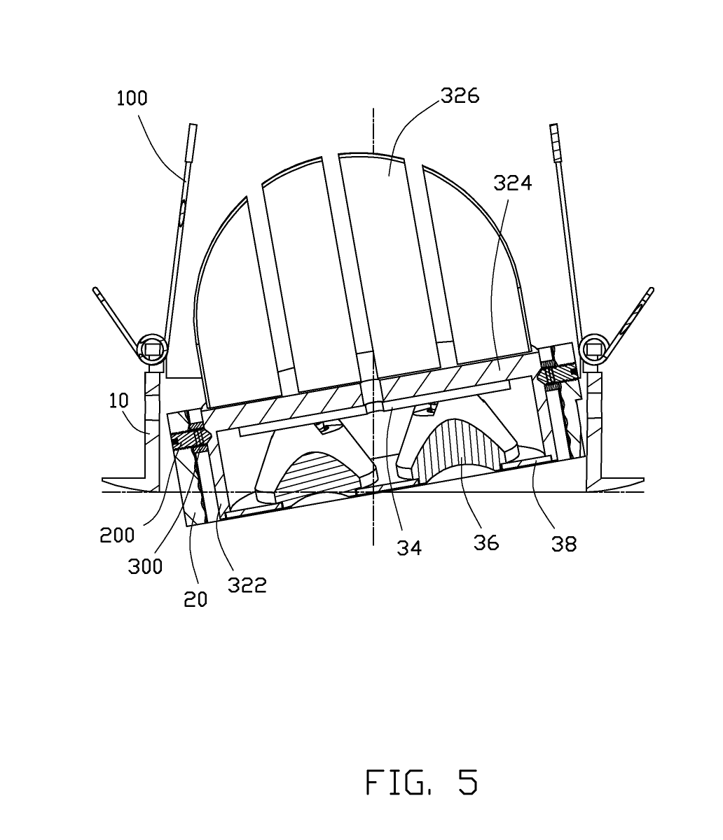

### DETAILED DESCRIPTION

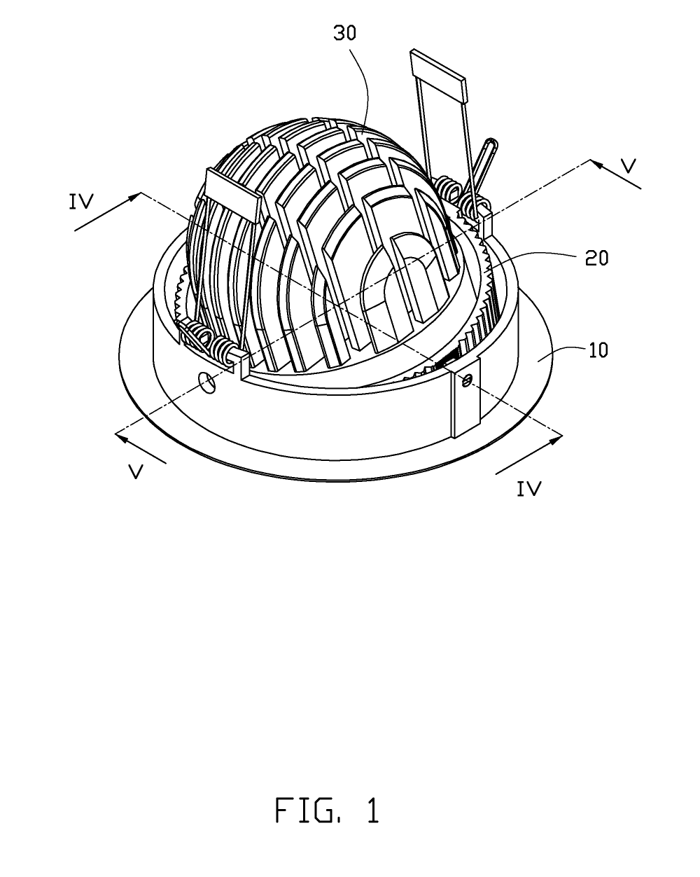

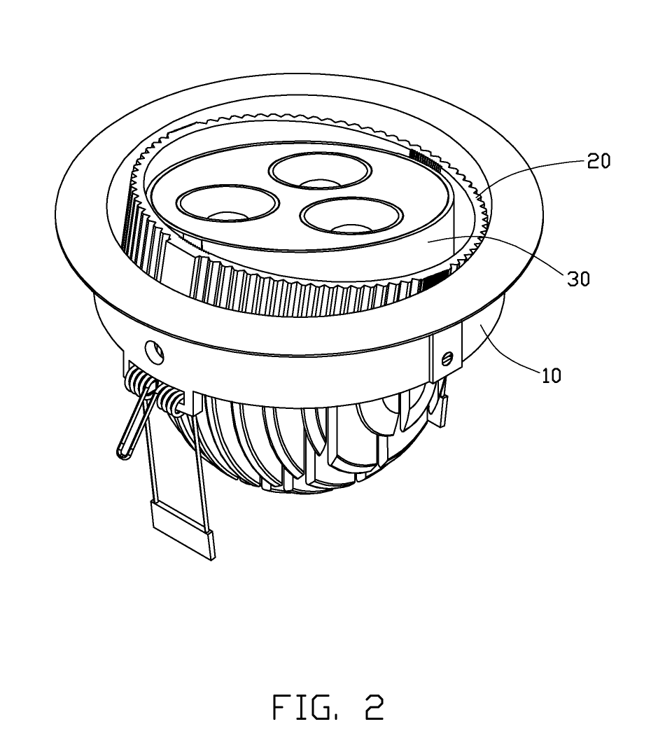

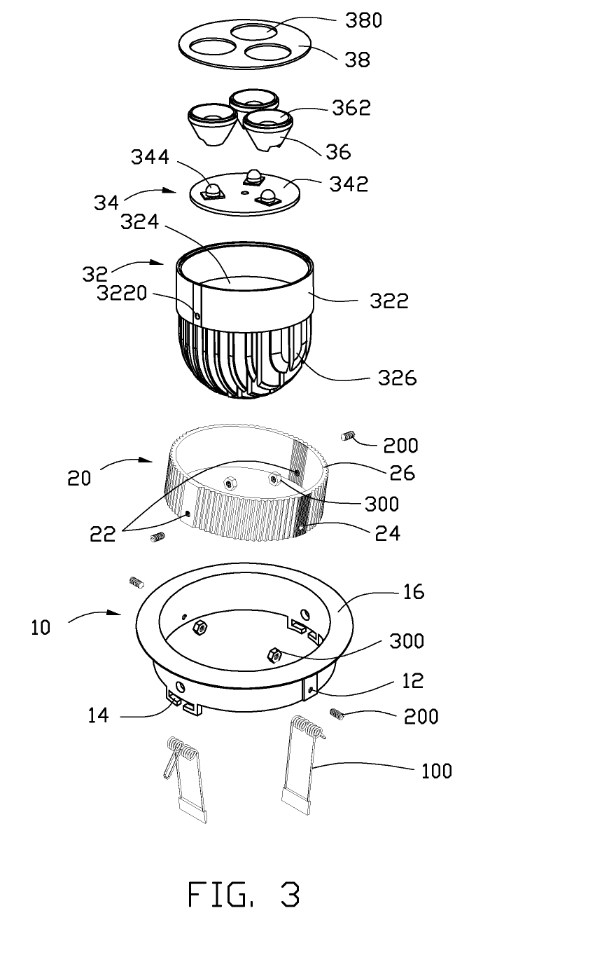

Referring to FIGS. 1-3, an LED lamp in accordance with an embodiment is shown. The LED lamp can be embedded in a panel (not shown) attached to a ceiling or an indoor wall or other places for illumination. The LED lamp comprises a base 10, a connecting member 20 pivotally mounted in the base 10, a lamp body 30 pivotally mounted in the connecting member 20.

The base 10 has an annular configuration and defines a circular opening therein for receiving the connecting member 20 and the lamp body 30 therein. The base 10 comprises a pair of ears 14 extending upwardly and perpendicularly from a circumference of an upper end thereof. The ears 14 are positioned symmetrically relative to a center of the base 10. Each ear 14 comprises a pair of curved parts (not labeled) extending from the upper end of the base 10 and facing to each other. A locking member 100 is made of a metal wire and has helical portions wrapping around the pair of curved parts of a corresponding ear 14, thereby pivotably securing the locking member 100 to the corresponding ear 14. The locking members 100 are provided for fixing the LED lamp to the panel. A pair of fixing orifices 12 are defined in a sidewall of the base 10, for engagingly receiving two corresponding pivots 200 therein. The base 10 further comprises an annular flange 16 extending horizontally and outwardly from a lower end of a circumference thereof. The flange 16 is provided for abutting a front face of the panel around a hole, whereby the lamp body 30 is exposed to a front or an underside of the panel via the hole defined in the panel.

The connecting member 20 has a configuration of a short tube and is made of a material with a good heat conductivity such as copper or aluminum. The connecting member 20 has an outer diameter slightly smaller that an inner caliber of the base 10, whereby the connecting member 20 is received wholly in the base 10 and separated from the base 10 with a predetermined gap. A pair of first pivoting holes 22 are defined in two opposite places of the connecting member 20, while a pair of second pivoting holes 24 are defined in another two opposite places of the connecting member 20. Two imaginary lines passing through the center of the connecting member 20 and respectively connecting the two first pivoting holes 22 and the two second pivoting holes 24 are perpendicular to each other. The second pivoting holes 24 are corresponding to the fixing orifices 12 of the base 10 and preferred to be blinded and do not pierce through an inner wall of the connecting member 20. A plurality of protruding strips 26 are formed on an outer circumferential surface of the connecting member 20 and parallel to a central axis of the connecting member 20. A plurality of protruding lines (not labeled) are densely formed on the outer circumference surface of the connecting member 20 around the first pivoting holes 22 and also formed on an inner surface of the connecting member 20 around the second pivoting holes 24 for facilitating a rotation of the connecting member 20 relative to the base 10 and the lamp body 30.

The lamp body 30 comprises a housing 32, an LED module 34 accommodated in the housing 32, a plurality of lenses 36 and a holding plate 38 holding the lens 36 in the housing 32. The housing 32 is integrally formed of a metal with good heat conductivity such as aluminum, copper or an alloy thereof. The housing 32 comprises an annular holder 322 at the bottom thereof, a conducting plate 324 formed on a top end of the annular holder 322 and a plurality of fins 326 integrally extending perpendicularly and upwardly from a top surface of the conducting plate 324.

The annular holder 322 has an outer diameter slight smaller that an inner diameter of the connecting member 20, whereby the annular holder 322 is received wholly in the connecting member 20 and separated from the connecting member 20 with a predetermined gap. A pair of engaging holes 3220 are respectively defined in two opposite places of an annular outer wall of the annular holder 322. The engaging holes 3220 are preferred to be blinded and do not pierce through an inner wall of the annular holder 322. The conducting plate 324 is circular and perpendicular to the annular wall of the annular holder 322.

The fins 326 are parallel to each other and spaced from each other with a constant distance. The fins 326 have arched configurations. Heights of the fins 326 are decreased from a center of the conducting plate 324 to a circumference of the conducting plate 324, whereby upper ends of the fins 326 cooperatively define a hemispherical surface.

The LED module 34 comprises a circular printed board 342 and a plurality of LEDs 344 (three in this embodiment) mounted on the printed board 342. The printed board 342 is received in the annular holder 322 of the housing 32 and attached to a bottom surface of the conducting plate 324. The holding plate 38 has a size slightly smaller than the annular holder 322 of the housing 32 and thus snugly received in the annular holder 322. The holding plate 38 defines three circular openings 380 located corresponding to the LEDs 344 of the printed board 342, whereby light emitted by the LEDs 344 passes through the holding plate 38 to provide an illumination. Each of the lenses 36 is cup-shaped. The lenses 36 are sandwiched between the printed board 342 and the holding plate 38. Each lens 36 defines a circular opening 362 in a bottom thereof for extension of light of a corresponding LED 344 therethrough. The cup-shaped lens 36 receives a corresponding LED 344 therein and abuts against a top surface of the holding plate 38 around a corresponding opening 380 of the holding plate 38 when the holding plate 38 is engagingly received in the annular holder 322.

In assembly of the LED lamp, the connecting member 20 is wholly received in the base 10 and pivotally connected to the base 10 by the two pivots 200. The lamp body 30 is surrounded by the connecting member 20 and is pivotally connected to the connecting member 20 by another two pivots 200. Therefore, the lamp body 30 is pivotable relative to the base 10 in two orthogonal orientations to thereby provide an illumination in various angles in the two orientations.

In detail, the two pivots 200 are extended through the two fixing orifices 12 of the base 10 and engagingly received in the two corresponding second pivoting holes 24 of the connecting member 20, to thus pivotally connect the base 10 and the connecting member 20 together. The connecting member 20 is thus pivotable relative to the base 10 about a first axis which is in the line extending through the two second pivoting holes 24. Another two pivots 200 are extended through the first pivoting holes 22 of the connecting member 20 and engagingly received in the two corresponding engaging holes 3220 of the annular holder 322 of the lamp body 30, to thus pivotally connect the connecting member 20 and the lamp body 30 together. The lamp body 30 is thus pivotable relative to the connecting member 20 about a second axis which is in the line extending through the first pivoting holes 22. A plurality of partition members 300 are respectively mounted around the pivots 200 and located between the connecting member 20 and the base 10 and between the connecting member 20 and the annular holder 322 of the lamp body 30 to separate the connecting member 20 from the base 10 and the annular holder 322 of the lamp body 30 from the connecting member 20 for facilitating a pivot of the connecting member 20 relative to the base 10 and a pivot of the lamp body 30 relative to the connecting member 20.

In use, heat generated by the LED module 34 is absorbed by the conducting plate 324 of the lamp body 30 and then is mainly conducted to the fins 326 via the conducting plate 324 and partially is conducted to the connecting member 20 via the annular holders 322, the pivots 200 and the partition members 300, to dissipate into ambient environment. Since the first and second axes are perpendicular to each other, the lamp body 30 is pivotable relative to the base 10 fixed in position about the first axis and second axis; thus, the lamp body 30 can be adjusted to provide an illumination in a wider range than a conventional lamp which is fixed in a determined direction.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A light emitting diode (LED) lamp, comprising:
a base defining an opening therein;
a connecting member received in the opening of the base and pivotably connected to the base; and
a lamp body surrounded by the connecting member and pivotably connected to the connecting member, the lamp body comprising an LED module in a bottom thereof and being exposed outside through bottoms of the base and the connecting member;
wherein the lamp body is pivotable to the base in two orientations.

2. The LED lamp as claimed in claim 1, wherein the connecting member is pivotable relative to the base about a first axis, while the lamp body is pivotable relative to the connecting member about a second axis.

3. The LED lamp as claimed in claim 2, wherein the first axis and the second axis are perpendicular to each other, the lamp body being pivotable relative to the base about both the first axis and the second axis.

4. The LED lamp as claimed in claim 3, wherein two pivots through which the first axis extends are extended through two opposite places of the base and engaged into the connecting member to pivotally connect the base and the connecting member together.

5. The LED lamp as claimed in claim 4, wherein two partition members are mounted around the two pivots and sandwiched between the base and the connecting member to separate the connecting member from the base.

6. The LED lamp as claimed in claim 5, wherein two additional pivots through which the second axis extends are extended through two additional opposite places of the connecting member and engaged into the lamp body to pivotally connect the connecting member and the lamp body together.

7. The LED lamp as claimed in claim 6, wherein two additional partition members are mounted around the two additional pivots and sandwiched between the connecting member and the lamp body to separate the lamp body from the connecting member.

8. The LED lamp as claimed in claim 7, wherein the lamp body comprises a housing having an annular holder in a bottom thereof, the annular holder being received in the connecting member and in which the two additional pivots are engaged.

9. The LED lamp as claimed in claim 8, wherein the lamp housing comprises a conducting plate formed on a top end of the annular holder and a plurality of fins extending upwardly from a top surface of the conducting plate, the fins being parallel to each other and decreasing gradually in height from a center toward a circumference of the conducting plate.

10. The LED lamp as claimed in claim 9, wherein the lamp body comprises a plurality of lenses and a holding plate, the LED module being received in the annular holder and having a circular circuit board attached to the conducting plate and a plurality of LEDs mounted on the circuit board.

11. The LED lamp as claimed in claim 10, wherein the each lens has a bottom end receiving a corresponding LED and an upper end abutting against the holding plate and sandwiched between the circuit board and the holding plate, the holding plate defining therein a plurality of circular openings corresponding to the lenses.

12. The LED lamp as claimed in claim 1, wherein the base and the connecting member each are annular shape, a plurality of protruding strips being formed on a circumferential surface of the connecting member.

13. A light emitting diode (LED) lamp, comprising:
a base defining an opening therein;
a connecting member received in the opening of the base and pivotally connected to the base; and
a lamp body comprising an annular holder at a bottom thereof, the annular holder being received in the connecting member and pivotally connected to the connecting member, the lamp body comprising an LED module received in the annular holder and being exposed outside through bottom of the base and the connecting member;
wherein the connecting member is rotatable relative to the base about a first axis, while the lamp body is rotatable relative to the connecting member about a second axis angled with the first axis.

14. The LED lamp as claimed in claim 13, wherein two partition members are sandwiched between the base and the connecting member to separate the connecting member from the base.

15. The LED lamp as claimed in claim 14, wherein two additional partition members are sandwiched between the connecting member and the annular holder to separate the annular holder from the connecting member.

16. The LED lamp as claimed in claim 15, wherein the lamp housing comprises a conducting plate formed on a top end of the annular holder and a plurality of fins extending upwardly from a top surface of the conducting plate, the LED module being attached to a bottom surface of the conducting plate.
